(19) United States
(12) Patent Application Publication
(10) Pub. No.: US 2014/0373616 A1
(43) Pub. Date: Dec. 25, 2014

(54) MECHANICAL CHARACTERIZATION OF CORE SAMPLES

(71) Applicant: CONOCOPHILLIPS COMPANY, Houston, TX (US)

(72) Inventors: David Victor AMENDT, Katy, TX (US); Seth BUSETTI, Houston, TX (US); Peter S. D'ONFRO, Katy, TX (US); Peter H. HENNINGS, Houston, TX (US)

(21) Appl. No.: 14/309,390

(22) Filed: Jun. 19, 2014

Related U.S. Application Data
(60) Provisional application No. 61/836,952, filed on Jun. 19, 2013.

(51) Int. Cl. G01V 11/00; E21B 47/00

(52) U.S. Cl. CPC G01V 11/00; E21B 47/00
USPC 73/152.01

(57) ABSTRACT

The invention relates to the correlating of mechanical and geological (e.g. compositional) information from a rock core or a large number of rock cores. A geological facies model may be created correlating mechanical and geological information, and allowing prediction of the mechanical properties of rock with given geological properties, such as composition, porosity, etc.

### CROSS-REFERENCE TO RELATED APPLICATIONS

This application claims benefit under 35 USC §119(e) of and priority to U.S. Provisional Application Ser. No. 61/836,952 filed 19 Jun. 2013, entitled “MECHANICAL CHARACTERIZATION OF CORE SAMPLES,” which is incorporated by reference herein in its entirety. This application is related to, and incorporates by reference in its entirety, U.S. patent application entitled “Core Sample Testing Protocol”, filed concurrently herewith.

### STATEMENT REGARDING FEDERALLY SPONSORED RESEARCH OR DEVELOPMENT

None.

### FIELD OF THE INVENTION

This invention relates to the mechanical characterization of rock, based on core samples, and the correlation of this mechanical data with compositional and/or other geological data about the rock.

### BACKGROUND OF THE INVENTION

It has become standard practice for those involved in hydrocarbon exploration and extraction to take a core sample from a subterranean formation and analyze it to obtain information on the composition and geophysical properties of the formation. Conventional methods generally involve extracting a core of a certain diameter and cutting a certain conventional length from that core, known as a bulk sample, taking a plug sample from that bulk sample and subjecting it to mechanical testing. Mechanical properties such as Young's modulus, ultimate compressive strength, etc can be determined from such testing. These properties can be used, for example, in designing a hydraulic fracturing process for a well or modeling borehole stability.

There have been some efforts to link mechanical properties obtained by core analysis to rock physics and reservoir quality parameters. Typically the core is sampled according to a statistical approach based on regular sample spacing, with sample frequency depending on the type of test. Large databases have been generated with data obtained in this way. However, the sampling and testing criteria can be prone to sampling bias, where certain abundant lithologies may be over-represented and other key lithologies that are volumetrically smaller may be under-represented and in some cases not sampled altogether. There is little assurance that different tests are conducted at the same depth or lithology, so that detailed synthesis of properties by geological rock type is difficult.

There are numerous issues that can affect conventional core analysis methods. In general, core preparation and analysis can be a costly and time consuming process especially when the process must be repeated many times over a large area. This can be particularly significant when analyzing non-conventional rocks such as shale whose properties can vary widely within a relatively small given area. Despite its widespread usage, current core testing techniques can suffer from inaccuracy and poor consistency. As a result, massive oilfield operations can be guided by incorrect data. These issues are particularly problematic when characterizing non-conventional rocks such as shale. Part of the problem also lies in the inadequacy of currently accepted models of rock properties and behaviors. For example, in non-conventional organic source rock reservoirs, elastic parameterization of the mechanical response (of the matrix) does not apply because organic source rocks tend to have higher volumes of clay and kerogen which contribute to elastic-plastic constitutive behavior.

### BRIEF SUMMARY OF THE DISCLOSURE

In one embodiment of the invention, a method of analyzing rock comprises:
a) taking a core of the rock and removing from the core at least one bulk sample;
b) removing at least one plug sample from each said bulk sample;
c) performing mechanical testing on each plug sample to determine a value for one or more mechanical properties selected from:
   (i) Young's Modulus,
   (ii) Poisson's Ratio,
   (iii) Ultimate Compressive Strength,
   (iv) Cohesion,
   (v) Angle of friction, or
   (vi) Fracture Toughness;
d) performing on material from the or each bulk sample one or more of:
   (i) petrophysical measurements to determine one or more of: matrix mineral composition, porosity, pore space constituent and total organic content;
   (ii) permeability-related measurements including one or more of: bulk density, grain density, gas-filled porosity determination, fluid saturation and effective total interconnected porosity;
   (iii) measurement of mineral composition using one or more of: X-ray diffraction and thin section mineral reconstruction.
e) correlating information from steps c) and d).

At least one bulk sample may be selected from each geological facies occurring in the core. Steps c) and d) may thus be applied to samples from different facies so that correlated data is obtained for different facies. Bulk samples may also be obtained from different cores and steps c) and d) performed to obtain further correlated data. This may allow a statistical analysis of how mechanical and geological data is linked.

Cores may be taken over a wide area so that an understanding of the correlation between mechanical and geological data can be built up for e.g. a whole field or region. For example, different cores may be taken from sites at least a mile apart, or at least 10 miles apart or more.

A geological facies model may be created correlating one or more properties from step c) with a geological facies at least partly defined by one or more properties from step d). This potentially allows the predicting of mechanical properties. For example, one may analyze a sample of rock to determine one or more of the properties listed in step d) and then use a facies model created using previously obtained correlated data from steps c) and d) to predict one or more of the mechanical properties listed in step c). The sample may come from drill cuttings, e.g. from a horizontal well. In such circumstances taking a core may be challenging and/or time consuming and it may be very helpful to be able to derive this mechanical information without taking cores.

When cores are taken, selection of a bulk core sample or samples may be made with reference to a geological facies model or log cluster model. Amongst other benefits, this may improve the chances of the core providing data from desired facies. As mentioned before, mechanical test results from a plurality of plug samples of the same geological facies may be statistically combined to give mean and standard deviation values for one or more of the values in step c). Of course, more than one of the plug samples may come from different bulk samples, which may be from the same core or from different cores.

Optionally, techniques may be used to improve the reliability and consistency of core data. For example, a computer tomography scan may be made of at least part of the core prior to selection and removal of the bulk sample or samples, to determine which region or regions of the core may provide one or more bulk samples suitable for plugging. A computer tomography scan may also be made of the bulk sample(s), after removal from the core, to check its ability to provide suitable plug samples for testing. A computer tomography scan may also be made of the plug sample, after removal from the bulk sample, to check its suitability for testing. Using such methods, it may be possible to avoid testing samples with e.g. a large number of cracks or voids and which may give misleading data when subjected to compression testing.

Optionally, two or more plugs of the same dimensions may be removed from a given bulk sample and subjected to mechanical testing (such as triaxial), the data from the testing (e.g. elastic strain or Young's Modulus) then being examined for consistency and accepted or rejected accordingly. The data could alternatively be change in plug failure strength with increasing confining pressure. Alternatively, the data could be the result from a Mohr-Coulomb shear failure interpretation.

### BRIEF DESCRIPTION OF THE DRAWINGS

A more complete understanding of the present invention and benefits thereof may be acquired by referring to the follow description taken in conjunction with the accompanying drawings in which:

FIG. 1 is a plot of the static to dynamic transform for Young's Modulus for different rock types in the Bakken Geological Horizon Model;

FIG. 2 is a ternary diagram which uses mineralogical parameters to provide well defined facies boundaries;

FIG. 3 is a static to dynamic Young's modulus plot, with the mechanical grouping following the Ternary facies boundaries of FIG. 2; and

FIG. 4 is a graphic representation of mean and standard deviation for various mechanical parameters from Examples 1 and 2.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The present invention provides tools and methods for generating mechanical test data from a core sample that is reliable and can be correlated to geological data (e.g. rock compositional data). Series of mechanical data and its correlated geological data can be gathered over a particular region or area. The data can be used to generate a searchable database that can guide oilfield decisions or other aspect of oil and gas exploration and extraction such as, but not limited to, hydrocarbon reservoir stress modeling.

One feature of the present invention is that the method does not force mechanical property data to obey or fit into conventional elastic response assumption and conform to Sonic logging outputs. Instead, the mechanical test results are grouped by depositional facies and may freely allow the data to define the most appropriate constitutive model to use for, for example, stress modeling applications. The present method treats rock deformations according to its measured response (with well-defined quality control measures throughout the lab test cycle). This approach may capture a more realistic view of the deformation response—which can be important for gathering a more realistic mechanical view of the subsurface.

It has been discovered that a better understanding of the properties of unconventional rock may be obtained by considering mechanical and geological properties of rock and their correlation with one another. Examples of geological properties include, but are not limited to, matrix mineral composition, porosity, pore space constituent and total organic content; permeability-related measurements such as bulk density, grain density, gas-filled porosity and fluid saturation; and mineral composition which can be measured, e.g. using X-ray diffraction and/or thin section mineral reconstruction. These properties are often obtained from relatively small samples such as rock cuttings brought to the surface during drilling.

The mechanical properties of subsurface litho-facies are dependent on specific rock characteristics that are determined through the depositional history of a basin. Using a geological facies classification system, the mechanical properties can be systematically linked to the composition and texture of unique rock types using various facies grouping scenarios. Composition and texture measurements can be made on the same bulk sample of rock, co-located with the triaxial testing (from core sample) and the combined data set is used to group mechanical properties.

The present invention can be configured to work with data that is available in horizontal well types. Mechanical properties that are derived from composition measurements can be used with cuttings analysis and mudlog data. Vertical pilot wells with whole core are used to characterize the rock types for mechanical, composition and texture properties. Pilot wells also provide a stratigraphic framework for distribution of the material properties. Integrating the pilot well results with the lateral heterogeneity determined from compositional analysis provides an opportunity to construct a mechanical stratigraphy with elastic, inelastic and failure properties using readily available near wellbore data.

In one emboidment, the present invention includes a whole core computer tomography (CT) scan that is used to identify the various rock types in the core. A geological facies model is used to select samples for mechanical testing. The mechanical testing program is designed to satisfy engineering requirements and link mechanical properties to composition and texture. A detailed quality control process is followed to ensure the final mechanical properties have been properly vetted. The quality controlled data is used in different mechanical grouping scenarios that are designed to work with existing data and facies methods. Ideally, the whole core is run through a CT scan prior to unloading from the acquisition core barrels. The whole core CT scan is used with the wireline logs and a preliminary facies model for sample selection. Bulk samples are selected for mechanical, compositional and textural properties. A typical bulk sample is 6″ to 1 foot in length and 4 inches in diameter, smaller diameter whole core can also be used. The samples are selected with input from the asset geologist; the data used to define the facies model should be complementary with the data that will be used to map the stratigraphic layering.

During the mechanical testing, the bulk samples undergo a series of quality control steps to ensure the data is of the highest quality. Initially, the bulk samples are CT scanned and mechanically damaged material is rejected. The bulk samples are then sent for triaxial test plugging and the test plugs are CT scanned before the triaxial test. The remaining carcass of rock is sent off for composition and texture measurements after the plugs are extracted from the bulk samples. The composition and texture analysis is performed on the portion of the remaining carcass co-located with the triaxial plugs. The rock composition is analyzed for matrix mineral composition, porosity, pore space constituent, and total organic content. Rock texture is characterized from thin sections for grain type, grain size distribution and degree of cementation. CT scans are also used to evaluate plug scale heterogeneity. The mechanical testing is co-located with the composition and texture measurements to allow one to directly compare the mechanical response of the bulk sample with the lithology and rock type facies.

Additional mechanical quality control steps are applied to ensure elastic parameter repeatability and true shear rock failure. The quality controlled data is the grouped together using a preliminary mechanical facies criteria that is tied to the geological facies model used in the sample selection.

The following examples of certain embodiments of the invention are given. Each example is provided by way of explanation of the invention, one of many embodiments of the invention, and the following examples should not be read to limit, or define, the scope of the invention.

### Example 1

A geological model relating to the Bakken formation (underlying parts of Montana, North Dakota, and Saskatchewan in North America) was used to select samples for mechanical testing in a well in that formation. A total of 21 bulk samples were used for mechanical testing. Samples were selected based on whole core suitability for mechanical plugging. Ideally, each facies would be sampled multiple times to generate a representative statistical analysis of grouped mechanical properties. Some of the facies displayed considerable mechanical damage and multiple bulk sampling was not possible in all facies types. A summary of the number of bulk samples by geological horizon is given in Table 1 below.

TABLE 1

| | |
|---|---|
| 4 Bulk Samples | LodgePole |
| 1 Bulk Sample | Scallion |
| 1 Bulk Sample | Upper Bakken Shale |
| 6 bulk Samples | Middle Bakken |
| 5 Bulk Samples | Lower Bakken Shale |
| 2 Bulk Samples | Upper Three Forks |
| 2 bulk Samples | Middle Three Forks |

Ideally, additional bulk samples would be taken in the Scallion and Upper Bakken shale to provide the required data sample points for statistical analysis. With the Scallion, the interval was too thin and only a very limited amount of core material was available. In the Upper Bakken Shale, friable, delicate de-laminating core material was encountered that proved to be challenging in acquiring suitable samples for mechanical testing. The diverse nature of mechanical response in the various mechanical facies underscores the importance of applying systematic quality control to ensure the reported mechanical data is properly vetted of and any pre-test mechanical damage that may influence the triaxal test result. The only option with the Upper Bakken Shale is to core another well and apply appropriate operational techniques to minimize the effect.

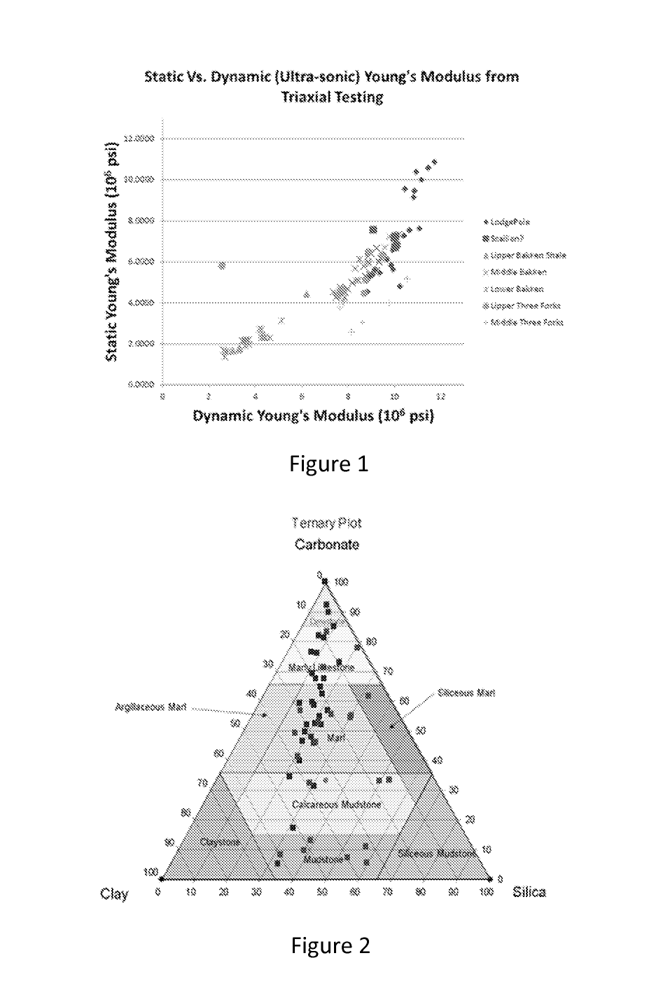

Mechanical data is grouped by rock type using the chosen facies grouping model. Mechanical grouping can be assessed by plotting the static to dynamic transform for Young's Modulus with the rock types identified (see FIG. 1). The static to dynamic crossplot can be used to assess the consistency of mechanical response within a mechanical facies grouping. The mechanical facies model offers an alternative to the frac gradient model and provides the geological facies “mechanical response” coupling that is required to map the mechanical properties in a 2 dimensional model using a well top model.

Using the Bakken geological horizon model it is possible to understand how the mechanical properties are distributed in 2 dimensional space using a simple well correlation model. One could easily take the next step to populate a 3 dimensional geomodel using the sample principles and techniques. Coupling mechanical properties to stratigraphic mapping techniques provides the geoscientist with a quantitative tool to predict stress response and rock constitutive response, including rock failure tendencies.

In this way, the application engineer may be provided with a geological inform method to predict borehole stability, hydraulic fracture response and reservoir drainage behavior across a play trend.

### Example 2

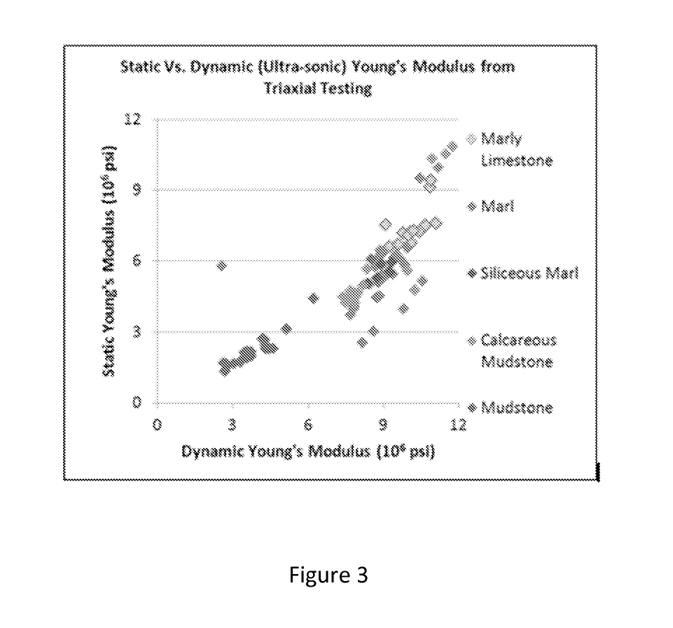

This alternative facies model is based on mineral composition derived from percentage ratios of silica, carbonate and clay. FIG. 2 is a ternary diagram which uses a mineralogically consistent fixed endpoint system to provide well defined facies boundaries. This type of model works well for understanding variations in mechanical response as a function of lithological composition alone. The technique couples well with cuttings analysis using XRD, XRF or any of the other commercial systems for determining lithological composition. The analysis steps for applying this methodology begin with plotting the composition data for each bulk sample on the ternary diagram. The mechanical test data is then grouped using the Ternary facies model. The static to dynamic Young's modulus plot is again generated but this time the mechanical grouping follows the Ternary facies boundaries (FIG. 3). Examining the rock type clustering on the Static to Dynamic crossplot provides information on the physical significance of the mechanical grouping: the tighter the clustering, the lower the statistical spread.

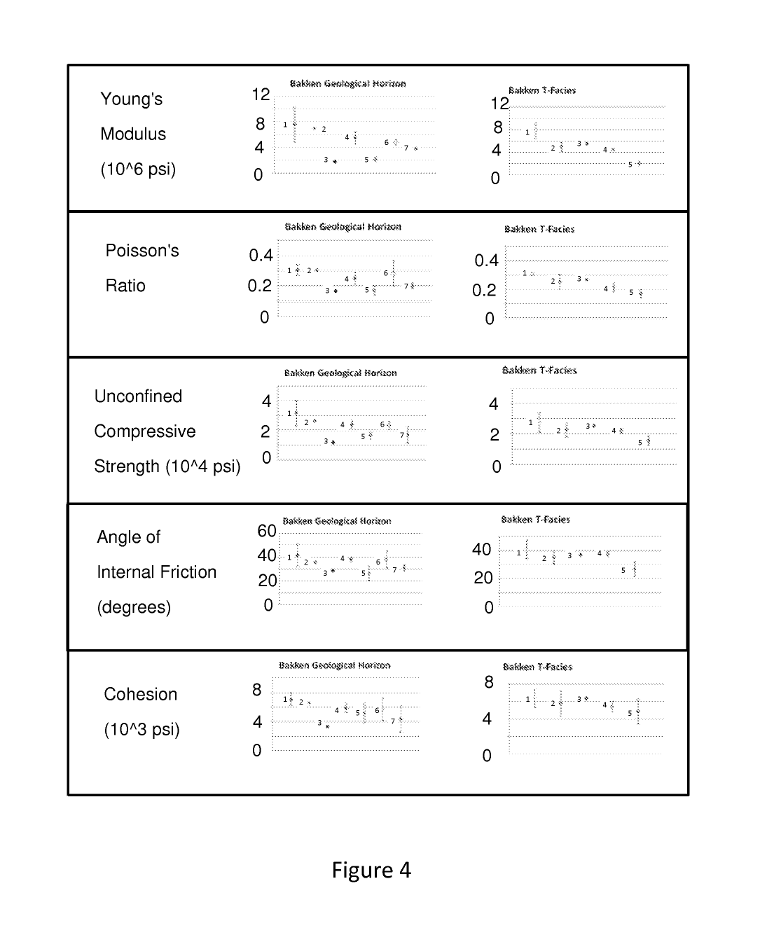

The mean and standard deviation have been calculated, using both facies models (Examples 1 and 2), for Young's modulus, Poisson's ratio, Unconfined Compressive Strength, Angle of Internal friction and Cohesion. This is shown in FIG. 4.

In summary, the mechanical facies and mechanical stratigraphy methodology facilitates the integration of geological principles and mapping techniques allowing us to honor the geological heterogeneities—as observed. Simple facies models can be used to group mechanical response following core protocols with stringent quality control. Multiple facies models can be considered for material property distribution based on specific applications and appropriate scale. Uncertainty in mechanical property distribution by facies type in is measureable and local knowledge can be easily integrated to refine model groupings. Both engineering and geological models can work together to provide the optimum solution to the stress modeling problem of study.

This has real and far-reaching practical significance in a situation where mechanical data is required but where it is impractical to take cores—either at all or in large numbers. For example, as a horizontal well is drilled, this statistically verified correlated data may be used to derive important mechanical properties by performing XRD analysis on cuttings as the drill progresses.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims, while the description, abstract and drawings are not to be used to limit the scope of the invention. The invention is specifically intended to be as broad as the claims below and their equivalents.

1. A method of analyzing rock comprising:
a) taking a core of the rock and removing from the core at least one bulk sample;
b) removing at least one plug sample from each said bulk sample;
c) performing mechanical testing on the or each plug sample to determine a value for one or more mechanical properties selected from:
(i) Young's Modulus,
(ii) Poisson's Ratio,
(iii) Ultimate Compressive Strength,
(iv) Cohesion,
(v) Angle of friction, or
(vi) Fracture Toughness;
d) performing on material from the or each bulk sample one or more of:
(i) petrophysical measurements to determine one or more of: matrix mineral composition, porosity, pore space constituent and total organic content;
(ii) permeability-related measurements including one or more of: bulk density, grain density, gas-filled porosity determination, fluid saturation and effective total interconnected porosity;
(iii) measurement of mineral composition using one or more of: X-ray diffraction and thin section mineral reconstruction.
e) correlating information from steps c) and d).

2. The method according to claim 1 wherein at least one bulk sample is selected from each geological facies occurring in the core.

3. The method according to claim 1 wherein steps c) and d) are applied to bulk samples from different cores.

4. The method according to claim 3 wherein said different cores are taken from sites at least a mile apart.

5. The method according to claim 3 wherein said different cores are taken from sites at least ten miles apart.

6. The method according to claim 1 further comprising creating a geological facies model correlating one or more properties from step c) with a geological facies at least partly defined by one or more properties from step d).

7. The method according to claim 6 further comprising analyzing a sample of rock to determine one or more of the properties listed in step d) and then using said facies model to predict one or more of the mechanical properties listed in step c).

8. The method according to claim 7 wherein the sample of rock is from drill cuttings.

9. The method according to claim 8 wherein the drill cuttings are from a horizontal well.

10. A method according to claim 1 wherein selection of said bulk core sample or samples is made with reference to a geological facies model or log cluster model.

11. A method according to claim 1 wherein mechanical test results from a plurality of plug samples of the same geological facies are statistically combined to give mean and standard deviation values for one or more of the values in step c).

12. A method according to claim 11 wherein two or more of said plurality of plug samples come from different bulk samples, which may be from the same core or from different cores.

13. A method according to claim 1 wherein a computer tomography scan is made of at least part of the core prior to selection and removal of the bulk sample or samples, to determine which region or regions of the core may provide one or more bulk samples suitable for plugging.

14. A method according to claim 1 wherein a computer tomography scan is made of said at least one bulk sample, after removal from the core, to check its ability to provide one or more suitable plug samples for testing.

15. A method according to claim 1 wherein a computer tomography scan is made of said at least one plug sample, after removal from the bulk sample, to check its suitability for testing.

16. A method according to claim 1 wherein two or more plugs of the same dimensions are removed from a given bulk sample and subjected to mechanical testing, the data from the testing then being examined for consistency and accepted or rejected accordingly.

17. A method according to claim 16, wherein the mechanical test is a triaxial test and said data is the elastic strain response or Young's Modulus for said at least two plug samples as determined by triaxial testing.

18. A method according to claim 16 wherein said data is change in plug failure strength with increasing confining pressure.

19. A method according to claim 16 wherein said data is a result from a Mohr-Coulomb shear failure interpretation.
